(19) United States
(12) Patent Application Publication
(10) Pub. No.: US 2026/0202255 A1
(43) Pub. Date: Jul. 16, 2026

(54) FOOD TEMPERATURE MEASURING DEVICE AND CHARGING CASE

(71) Applicant: Jinlong Lin, Shenzhen (CN)

(72) Inventor: Jinlong Lin, Shenzhen (CN)

(21) Appl. No.: 19/027,664

(22) Filed: Jan. 17, 2025

(30) Foreign Application Priority Data
Jan. 10, 2025 (CN) 202520063403.4

(51) Int. Cl. G01K 1/08; G01K 1/02; G01K 1/024; G01K 1/14

(52) U.S. Cl. CPC G01K 1/08; G01K 1/024; G01K 1/026; G01K 1/14; G01K 2207/06; G01K 2215/00

(57) ABSTRACT

A food temperature measuring device, comprising a charging case; and an elongated food thermometer detachably received in the charging case, wherein the charging case is configured to charge the elongated food thermometer, and comprises a body portion having a pivot axis and an end cap, one end of the end cap is pivoted to the pivot axis of the body portion, and the other end of the end cap rotates clockwise or counterclockwise relative to the body portion by a predetermined angle around the pivot axis; a receiving space configured for accommodating the elongated food thermometer is defined in the body portion, and an opening is formed in a top end of the body portion corresponding to the receiving space and communicates with the receiving space to allow the elongated food thermometer to be inserted into the receiving space via the opening.

### CROSS-REFERENCE TO RELATED APPLICATIONS

This application claims the benefit of priority to Chinese Patent Application Number 202520063403.4 filed on Jan. 10, 2025, in the China National Intellectual Property Administration. The entire contents of the above-identified application are hereby incorporated by reference.

### TECHNICAL FIELD

The present disclosure belongs to the technical field of thermometers, and specifically relates to a kitchen thermometer, particularly a food temperature measuring device for measuring the change of temperature of a meat product in a roasting process.

### BACKGROUND ART

A food temperature measuring device is a type of kitchen thermometer. When the elongated food thermometer is in use, it is usually necessary to insert the elongated food thermometer into food to be cooked, thereby obtaining the food temperature in real time in the cooking process. At present, the power supply used by a meat thermometer on the market is a Farad capacitor, i.e., a supercapacitor. The Farad capacitor has the shortcoming that its self-discharge effect will result in that the power will be quickly used up, so that a failure phenomenon of the meat thermometer occurs. In addition, the existing meat thermometers are complex in structure design, and inconvenient to assembly and use, and have structures requiring further optimization.

### BRIEF DESCRIPTION OF DRAWINGS

In order to illustrate technical solutions in embodiments of the present application or the prior art more clearly, the accompanying drawings required for use in description of the embodiments or the prior art will be briefly introduced below. Obviously, the accompanying drawings in the description below are merely some of the embodiments of the present application, and those of ordinary skill in the art may still derive other drawings according to the accompanying drawings without creative efforts.

FIG. 1 is a three-dimensional oblique view of a food temperature measuring device involved in the present disclosure.

FIG. 2 is an exploded schematic view of the food temperature measuring device shown in FIG. 1, wherein an end cap is rotated backwardly by a certain angle.

FIG. 3 is an exploded schematic view of a side opposite to the food temperature measuring device shown in FIG. 2, wherein the end cap is rotated forwardly by a certain angle.

FIG. 4 is a schematic diagram of a three-dimensional structure of the internal structure of the food temperature measuring device shown in FIG. 1 after removing the cap body of the end cap and the housing of a body portion.

FIG. 5 is a schematic diagram of the food temperature measuring device shown in FIG. 4 after removing a receiving sleeve at the periphery of a elongated food thermometer.

FIG. 6 is a cross-section view of the food temperature measuring device shown in FIG. 1 after being cut away along a long axis direction.

FIG. 7 is a schematic view of the internal structure of the elongated food thermometer shown in FIG. 2.

FIG. 8 is a schematic diagram of the wireless communication connection of the food temperature measuring device involved in the present disclosure after being inserted into meat food, with a cell phone.

FIG. 9 is a schematic diagram of a holder structure formed in such a way that after one end of the end cap of the elongated food thermometer shown in FIG. 1 is rotated away, a part of the elongated food thermometer in a charging case is ejected and cooperates with the rotating end of the end cap.

FIG. 10 is a schematic diagram of a variant example of the food temperature measuring device involved in the present disclosure.

### DETAIL DESCRIPTION

The technical solutions in embodiments of the present application will be clearly and completely described below in conjunction with the accompanying drawings in the embodiments of the present application. Apparently, the embodiments described are merely part of the embodiments of the present application, rather than all of them.

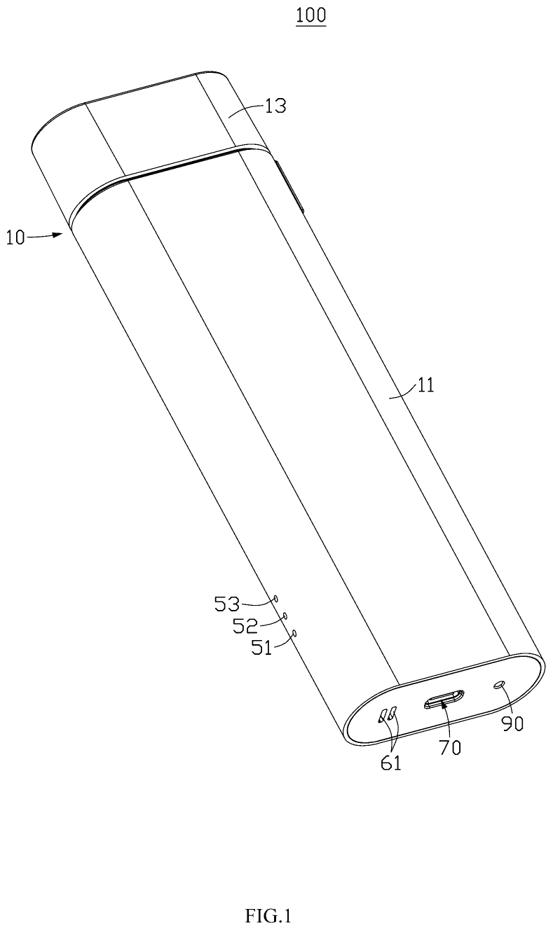

Please refer to FIGS. 1 to 3 at the same time, a food temperature measuring device 100 involved in the present disclosure includes a charging case 10 and a elongated food thermometer 20. The food temperature measuring device 100 is entirely similar to a lighter or a strip-shaped power bank in terms of appearance, and has characteristics of being lightweight and portable. The elongated food thermometer 20 is received on one side in the charging case 10 along the long axis direction of the charging case 10. Specifically, the charging case 10 is used to charge the elongated food thermometer 20 in real time. The elongated food thermometer 20 is received in the charging case 10 and can be automatically ejected from the charging case 10.

The charging case 10 includes a body portion 11 and an end cap 13 rotatably mounted on one end of the body portion 11. The body portion 11 includes an inner frame 111 and a housing 110 encompassing the periphery of the inner frame 111.

The inner frame 111 is a receiving slot structure with an open front face, which is formed by a top wall 111a, a bottom wall 111b, two opposing side walls 111c and a rear wall 111d jointly, and is provided therein with elements such as a receiving sleeve 12, a control circuit board 30 and a battery 40 described later. One end of the end cap 13 is pivoted to one side of the top wall 111a of the inner frame 111, so that the end cap 13 is pivotable with respect to the body portion 11. A narrow opening 1111 running through the side wall 111c and the top wall 111a is provided at the junction of the side wall 111c and the top wall 111a of the inner frame 111 away from the pivot of the end cap 13. The opening 1111 is used to guide the ejection direction of the elongated food thermometer 20, so that the elongated food thermometer 20 is ejected vertically upwardly along the direction of the opening 1111 during the ejection. Moreover, the opening 1111 also facilitates access to the elongated food thermometer 20 from the charging case 10.

The housing 110 is made of a metallic material, and is a flat bar-shaped shell structure that is hollow and open at both ends for socketing over and encompassing the periphery of the inner frame 111. The side wall of the housing 110 is also provided with a narrow opening 1101. The opening 1101 on the housing 110 corresponds to the opening 1111 on the inner frame 111 when the housing 110 is socketed over the inner frame 111. Two recesses (labeled in the figure) are spaced apart in the rear wall 111d of the inner frame 111, a magnet 105 being embedded and received in each recess. The magnet 105 can bring a certain adsorption force to the housing 110 to firmly fix the housing 110.

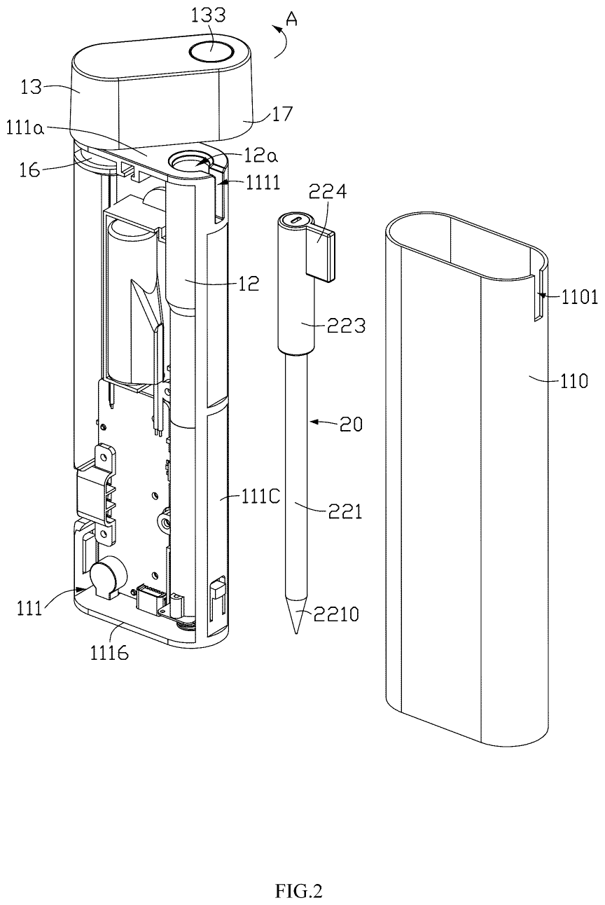

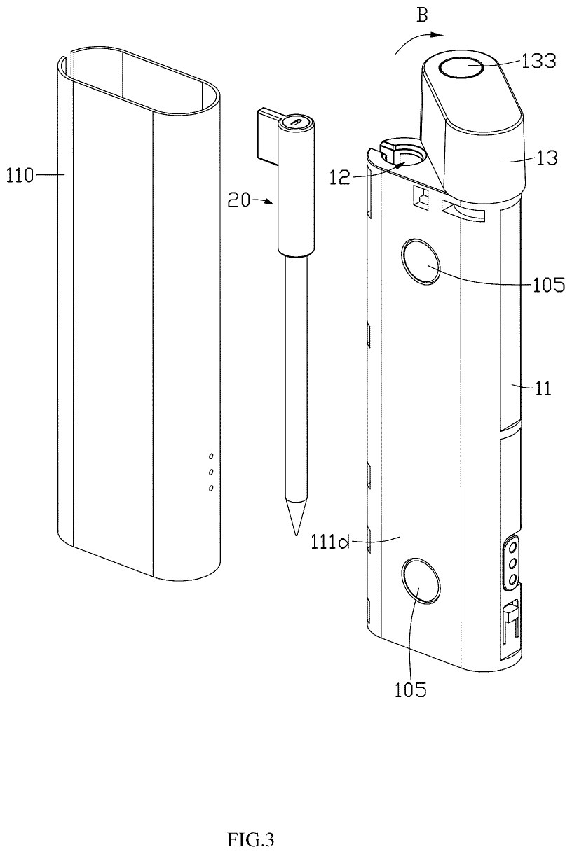

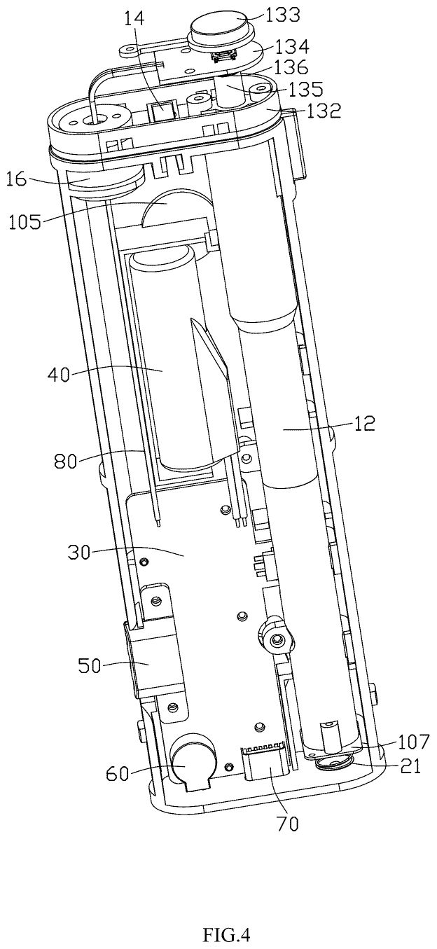

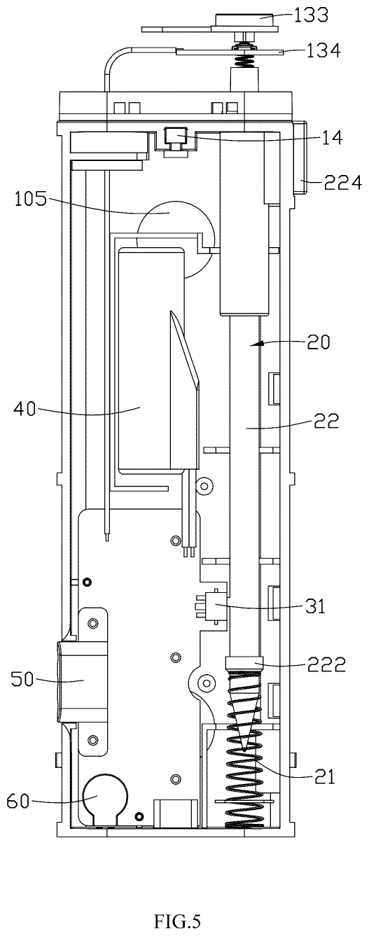

A receiving sleeve 12 is further mounted in the inner frame 111 of the body portion 11. The receiving sleeve 12 is mounted on one side in the inner frame 111 along the length direction of the body portion 11, and is a hollow cylinder for receiving the elongated food thermometer 20. An opening 12a is provided at the top of the receiving sleeve 12. The opening 12a runs through the top wall 111a of the inner frame 111 and is in communication with the opening 1111 and the opening 1101, whereby the elongated food thermometer 20 can be inserted into the receiving sleeve 12 from the top wall 111a of the body portion 11 through the opening 12a. Please refer to FIGS. 4 and 5, one end of the receiving sleeve 12 rests against the inner surface of the top wall 111a of the body portion 11 in contact with the end cap 13, and the other end rests against a stopper 107 mounted in proximity to the bottom wall 111b. The top wall of the inner frame 111 of the body portion 11 is also provided with a pivot portion 16 that is rotatably connected to the end cap 13 with respect to each other. The pivot portion 16 is a hollow cylinder that can be used for the passage of wires in the body portion 11. Taking the pivot portion 16 as a rotating shaft, one end of the end cap 13 is rotated backwardly in the direction of arrow A shown in FIG. 2 or forwardly in the direction of arrow B shown in FIG. 3 with respect to the body portion 11, and can be positioned in a rotated position. Preferably, one end of the end cap 13 is rotated at an angle of 0 to 45° with respect to the body portion 11.

As shown in FIGS. 2 and 3, the end cap 13 includes a cap body 131 having a cavity and a base portion 132, the cap body 131 being socketed over and snapped to the base portion 132. In one embodiment, the cap body 131 and the base portion 132 are in an integrally molded structure, and the lower end face of the base portion 132 is a smooth surface. Correspondingly, the surface of the top wall 111a of the inner frame 111 is also a smooth plastic plate, facilitating a seamless connection with the lower end face of the base portion 132.

As shown in FIGS. 4, 5 and 6, the end cap 13 further receives a button 133, a printed circuit board 134, a connecting member 135, and a second elastic member 136 therein. An end face of the cap body 131 is provided with a through hole, from which the upper surface of the button 133 is exposed. A user can trigger a contact on the printed circuit board 134 by pressing the button 133, so that he/she can confirm the power level of the food temperature measuring device 100. The printed circuit board 134 is located under the button 133, and the button 133 is in contact with the contact 1341 on the upper surface of the printed circuit board 134. The second elastic member 136 is provided in the connecting member 135, one end of which rests against the lower surface of the printed circuit board 134 and is in electrical conduction with the printed circuit board 134, and the other end of which passes through the connecting member 135 and rests against a conductive portion 138 provided at the lower end of the connecting member 135 and is in electrical conduction with the conductive portion.

Further, since one end of the end cap 13 is rotatable with respect to the body portion 11, in order to improve the degree of stability of the end cap 13 with respect to the body portion 11 when the end cap is reset, and to prevent random rotation of the end of the end cap 13 away from the pivot portion 16 with respect to the body portion 11 when the end cap 13 is detached from the upper end of the body portion 11 due to an external force on the food temperature measuring device 100 or the like, a magnetic suction means can be provided between the end cap 13 and the body portion 11. In this embodiment, as shown in FIG. 5, a magnet 14 is fixed to the upper surface of the base portion 132 of the end cap 13, and another magnet 14 with opposite magnetic polarities is fixed to the inner surface of the top wall 111a of the body portion 11 adjacent to the base portion 132. Therefore, the end cap 13 can be positioned at the upper end of the body portion 11 by mutual magnetic attraction forces of the two magnets 14 with opposite magnetic polarities, and the end of the end cap away from the pivot portion 16 is not liable to detaching from the body portion 11.

Please refer back to FIG. 1, the food temperature measuring device 100 further includes a control circuit board 30, a battery 40, a lamp holder 50 secured to one of the long sides of the control circuit board 30, an alarm 60 spaced apart and secured to one of the short sides of the control circuit board 30, a USB charging port 70 and a plurality of wires 80, which are mounted in the body portion 11. The battery 40, the lamp holder 50, the alarm 60, the USB charging port 70, and the plurality of wires 80 are all electrically connected to the control circuit board 30 and controlled by the control circuit board 30. For example, the control circuit board 30 may control charging actions directed at the battery 40 as well as the flickering of an indicator lamp on the lamp holder 50 and the flickering or beeping or the like of the alarm 60. A detection switch 31 is also fixed at the end of the control circuit board 30 opposite to the lamp holder 50. One end of the detection switch 31 passes through the housing of the receiving sleeve 12 so as to be electrically connected to the elongated food thermometer 20 received therein. The detection switch 31 is used to detect the power level of the elongated food thermometer 20. For example, when the elongated food thermometer 20 is fully charged by the charging case 10, the control circuit board 30 will control the alarm 60 to flash red light to alert a user.

In this embodiment, the lamp holder 50 is provided with an indicator lamp 51 for displaying the power level of the battery 40, an indicator lamp 52 for displaying the power level of the elongated food thermometer 20, and a wireless signal indicator lamp 53; and the alarm 60 includes a set of warning lamps 61 capable of giving out light. The indicator lamps 51, 52, 53, the alarm lamps 61, and the USB charging port 70 are exposed from through holes formed in the housing 110 and openings formed in the bottom wall 111b of the body portion 11, respectively. One end of one set of wires 80 is electrically connected to the battery 40, and the other end is electrically connected to the control circuit board 30. One end of the other set of wires 80 is connected to the control circuit board 30, and the other end is electrically connected to the printed circuit board 134 after passing through the pivot portion 16.

It could be understood that in a variant example, the charging case 10 may also replace the USB charging port 70 with a Tepc-C port. The Tepc-C port can realize fast charging, which greatly improves the charging efficiency of the charging case 10, and in turn realizes cyclic charging for the elongated food thermometer 20, thereby improving the endurance of the elongated food thermometer 20, and significantly improving the convenience and environmental protection performance of the elongated food thermometer 20 when in use.

Further, as shown in FIG. 1, a drainage hole 90 is also formed in the bottom wall 111b of the body portion 11 away from the end cap 13. The drainage hole 90 is used to discharge moisture in the charging case 10 to the outside, and is conductive to heat dissipation from the charging case 10.

As shown in FIGS. 2, 4, 5 and 6, a thermometer shell 22 includes, in terms of appearance, a probe portion 221 for at least partially extending to the interior of a food, and a handle portion 223 connected to one end of the probe portion 221. The probe portion 221 is a metal rod body made of stainless steel or the like, and the handle portion 223 is an insulator. A first elastic member 21 is provided at the bottom of the receiving sleeve 12. One end of the first elastic member 21 has a retaining ring 222 fixed thereto, and the other end rests against the bottom wall 111b of the body portion 11 away from the end cap 13. Most of the first elastic member 21 and the retaining ring 222 are stored at the end in the receiving sleeve 12 away from the end cap 13, and the retaining ring 222 can move up and down together with the first elastic member 21. In the process of the elongated food thermometer 20 being inserted into the receiving sleeve 12, the front end of the probe portion 221 will penetrate into the retaining ring 222 and the first elastic member 21 and is snapped to the inner wall of the retaining ring 222, thereby driving the retaining ring 222 to move downwardly, and in turn compressing the first elastic member 21 through the retaining ring 222. In a state where the elongated food thermometer 20 is fully stored in the receiving sleeve 12, the first elastic member 21 is in a compressed state and accumulates elastic potential energy, thereby imparting an elastic force to the elongated food thermometer 20.

When the end of the end cap 13 away from the pivot portion 16 (also referred to as a “rotating end”) is rotated away from the upper end face of the body portion 11, the conductive portion 138 at the lower end of the end cap 13 releases the pressing force on the elongated food thermometer 20, and the elongated food thermometer 20 is ejected from the receiving sleeve 12 of the charging case 10. During ejection, a stepped structure (stopper) 121 formed on the inner wall of the receiving sleeve 12 will stop the retaining ring 222 to prevent the retaining ring from detaching from the receiving sleeve 12 along with the elongated food thermometer 20.

In this embodiment, the handle portion 223 is made of a ceramic material, which can fulfill functions of insulation and heat insulation. The handle portion 223 wraps around a first portion 231 of a main PCB 23 and fixedly connects the first portion 231 to the inner wall of the handle portion 223. More specifically, the handle portion 223 wraps around an antenna unit 26 and a charging positive pin 27. The handle portion 223 in this embodiment may employ an insulating material, e.g., a ceramic material, that can withstand high temperatures and has low heat conductivity. In addition, a hook-up sheet 224 is integrally formed at the upper end of the handle portion 223. The hook-up sheet 224 protruding vertically from the side wall of the handle portion 223 is received in the opening 1111 on the side wall of the housing 110 and facilitating holding the elongated food thermometer 20 by the user. By providing the handle portion 223, on the one hand, the antenna unit 26 and the first portion 231 can be firmly fixed inside the handle portion 223 to ensure the stability of the electrical connection between these components and other components; on the other hand, the handle portion 223 has a heat insulation effect, and can reduce adverse influences of the high temperature environment outside the handle portion 223 on the antenna unit 26 and the first portion 231 when the elongated food thermometer 20 is used in the process of cooking food. In some embodiments, the temperature sensor 24 includes a first temperature sensor and a second temperature sensor. The first temperature sensor is provided in the tip portion 2210 of the probe portion 221 for sensing the internal temperature of the food. The second temperature sensor is provided in the handle portion 223 for sensing the ambient temperature. The first temperature sensor is in contact with the tip portion 2210 so as to sense the internal temperature of the food via the tip portion 2210. The second temperature sensor is in contact with the charging positive pin 27 so as to sense the ambient temperature (e.g., the temperature inside an oven) via the charging positive pin 27. In the above embodiment, the charging positive pin 27 also serves as a heat conduction member when the second temperature sensor senses the ambient temperature, which prevents the second temperature sensor from being exposed to the thermometer shell 22 while improving the accuracy of the second temperature sensor in sensing the ambient temperature, ensuring the sealing performance of the interior of the thermometer shell 22.

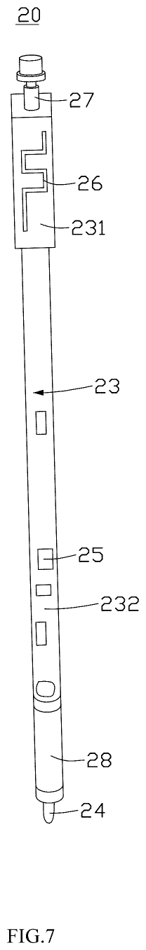

Please refer to FIGS. 2 and 7 together, the elongated food thermometer 20 includes the thermometer shell 22, the main PCB 23 provided in the thermometer shell 22, the temperature sensor 24, the communication unit 25, and the antenna unit 26. Both the temperature sensor 24 and the communication unit 25 are electrically connected to the main PCB 23. Wherein the temperature sensor 24 is used to sense the obtained temperature information. The communication unit 25 is a Bluetooth chip, which is electrically connected to the temperature sensor 24 and is used to send the temperature information to the outside through the antenna unit 26.

In this embodiment, both the communication unit 25 and the antenna unit 26 are integrated on the main PCB 23. The main PCB 23 includes a first portion 231 extending into the handle portion 223 and a second portion 232 located in the probe portion 221. Wherein the antenna unit 26 is located on the first portion 231 and the communication unit 25 is located on the second portion 232.

In this embodiment, the elongated food thermometer 20 further includes the charging positive pin 27 provided on the main PCB 23 away from the tip portion 2210. The charging positive pin 27 is in detachable contact with the conductive portion 138. The conductive portion 138 is in electrical conduction with the charging positive pin 27 when one end of the end cap 13 is reset from a rotated position to a position directly above the body portion 11, thereby starting to charge the elongated food thermometer 20 by means of the battery 40 in the body portion 11.

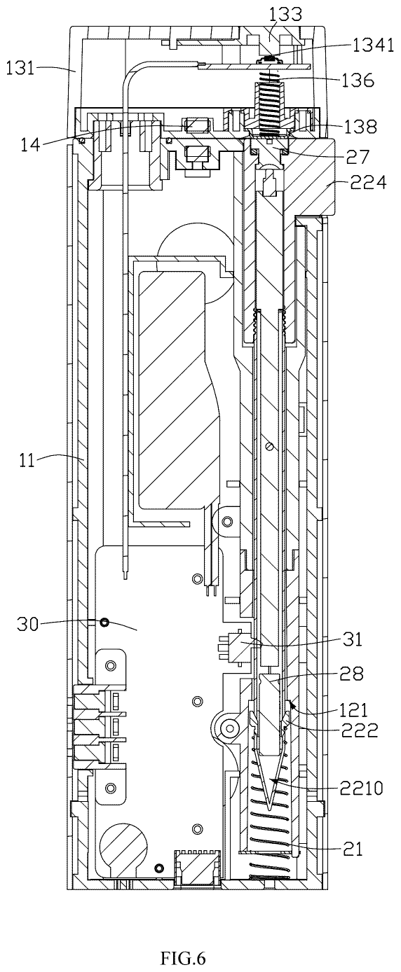

Please refer to FIGS. 6 and 7 together, in this embodiment, the elongated food thermometer 20 further includes a power storage unit 28 provided at an end of the main PCB 23 opposite to the charging positive pin 27. The power storage unit 28 is provided in the probe portion 221 adjacent to the tip portion 2210 of the probe portion 221. The power storage unit 28 is electrically connected to the main PCB 23 to supply power to the main PCB 23. In some embodiments, the power storage unit 28 is a supercapacitor. The detection switch 31 is used to detect the power level of the power storage unit 28.

In the above embodiments, the elongated food thermometer 20 is used in cooperation with the charging case 10, and in a state where the elongated food thermometer 20 is stored in the charging case 10, the probe portion 221 of the elongated food thermometer 20 is usually confined in the receiving sleeve 12 of the charging case 10, so that the relative position of the probe portion 221 in the charging case 10 is relatively stable.

Hereinafter, the cooperative relationship between the charging case 10 and the elongated food thermometer 20 of the food temperature measuring device 100 is illustrated.

Please refer to FIGS. 2, 3, 5 and 6 together, when a user wants to store the elongated food thermometer 20 in the charging case 10, the top of the handle portion 223 of the elongated food thermometer 20 is pressed by a hand, and when the top is approximately flush with the upper end face of the body portion 11, the end of the end cap 13 away from the pivot portion 16 is rotated back and positioned in a position where it is docked with the body portion 11, thus the elongated food thermometer 20 can be reliably stored, and an operation of charging the thermometer 20 is started. More specifically, after the elongated food thermometer 20 is fully loaded into the charging case 10, the hook-up sheet 224 on a lateral side of the handle portion 223 is correspondingly received in the opening 1111 on the side wall at the upper end of the charging case 10, and the conductive portion 138 at the lower end of the end cap 13 rests against the charging positive pin 27 at the upper end of the elongated food thermometer 20 with respect to each other and is in electrical conduction with the charging positive pin, thus achieving that the charging case 10 charges the elongated food thermometer 20 in real time. At this time, the front end of the elongated food thermometer 20 is clamped into the retaining ring 222 inside the receiving sleeve 12, and the first elastic member 21 is pressed downwardly by the retaining ring 22, so that the first elastic member 21 contracts and accumulates elastic potential energy.

When it is necessary to remove the elongated food thermometer 20, the user can turn the end of the end cap 13 away from the pivot portion 16 outwardly from both sides of the end cap 13. At this time, the other end of the end cap 13 will rotate around the pivot portion 16. When the end of the end cap 13 away from the pivot portion 16 is rotated away from the upper end face of the body portion 11, the conductive portion 138 at the lower end face of the end cap 13 shown herein will release the pressing force on the charging positive pin 27 of the elongated food thermometer 20. At this time, the first elastic member 21 wound around the tip portion 2210 of the thermometer 20 will be elastically reset such that the elongated food thermometer 20 will be automatically ejected from the charging case 10 under the elastic restoring force released by the first elastic member 21. Afterwards, the user can easily take out the elongated food thermometer 20 from the charging case 10 by holding the hook-up sheet 224 with his/her hand.

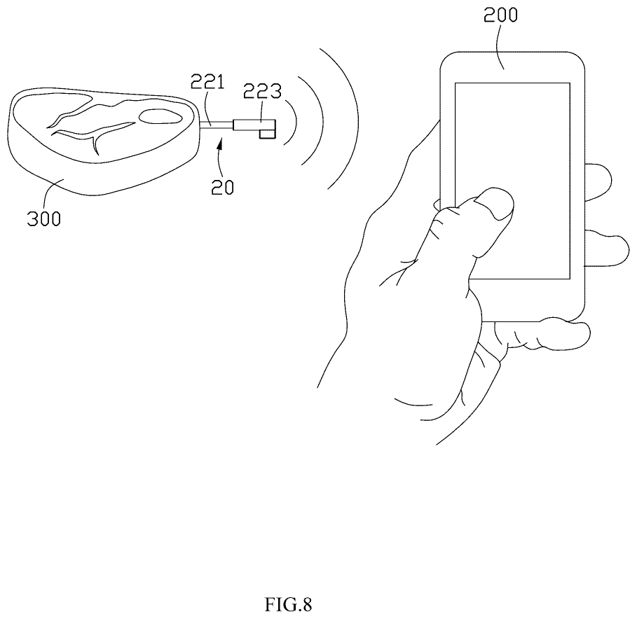

As shown in FIG. 8, the elongated food thermometer 20 may be in wireless communication connection with a terminal device such as a cell phone 200 or other display apparatus through the communication unit 25 and antenna unit 26 thereof to send information about its own power level or data signals of the measured food temperature and ambient temperature to the terminal device or the display apparatus. For example, the cell phone 200 is equipped with an APP for mated use with the food temperature measuring device 100, and after the probe portion 221 of the elongated food thermometer 20 is inserted into a meat food 300 such as a steak or a pork chop, the user can open the APP to view in real time the information about the power level of the elongated food thermometer 20, the data information of the measured food temperature and ambient temperature, etc.

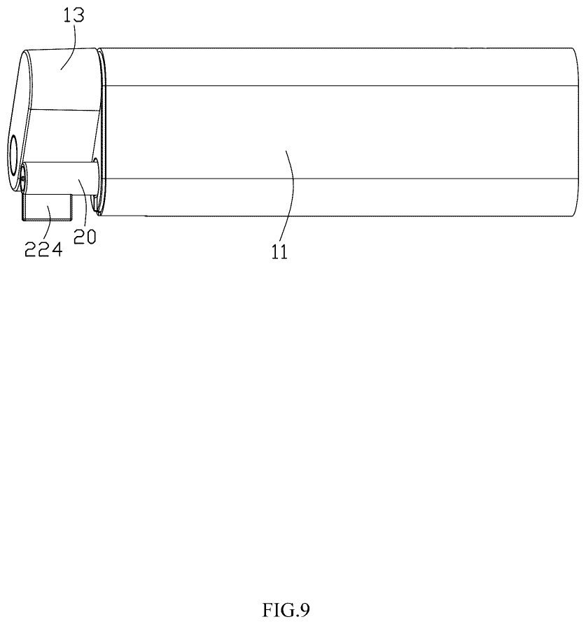

As shown in FIG. 9, the food temperature measuring device 100 of the present disclosure also has another function. Specifically, the end of the end cap 13 away from the pivot portion 16 can be rotated at an angle of up to 45 with respect to the body portion 11, so that after the end of the end cap 13 away from the pivot portion 16 is rotated away from the body portion 11, there is a certain included angle between the end cap 13 and the upper end face of the body portion 11. At the same time, the elongated food thermometer 20 is automatically ejected from the charging case 10, and partially protrudes from the upper end face of the body portion 11. Therefore, the handle portion 223 of the elongated food thermometer 20 which is exposed to the body portion 11 cooperates with the rotating end 17 of the end cap 13 to form a holder structure, which supports the body portion 11 in an inclined manner. As such, the user can put the whole of the charging case 10 on a table in an inclined manner, which is convenient to access and also can save space.

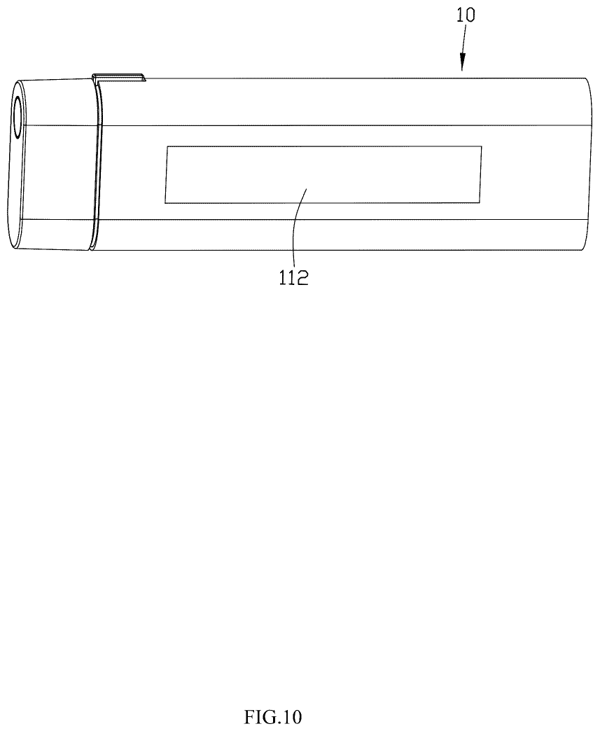

As shown in FIG. 10, as a variant example of the present disclosure, a display screen 112 may also be provided at the back of the body portion 11 of this food temperature measuring device 100, and the display screen 112 is exposed through an opening in the housing 110. The display screen 112 is electrically connected to the control circuit board 30 and the battery 40 of the charging case 10 via leads, such that the control circuit board 30 can control the on/off of the display screen 112 and displayed contents. The main PCB 23 inside the elongated food thermometer 20 has a data transmission line fixed thereto, through which the temperature sensor 24 is electrically connected to the control circuit board 30. The control circuit board 30 also has a microprocessor fixed thereto, and the microprocessor can receive a digital signal transmitted from the temperature sensor 24 of the elongated food thermometer 20 and display the digital signal of the temperature through the display screen 112. After the temperature sensor 24 inside the probe portion 221 measures the internal temperature of the food, the real-time temperature is converted into a digital signal, and the digital signal is transmitted to the microprocessor on the control circuit board 30 via the data transmission line for data processing and conversion, and then displayed via the display screen 112. In addition, the display screen 112 may also display information such as the power level of the power storage unit 28 of the elongated food thermometer 20 and the state of the charging case 10 charging the elongated food thermometer 20. As such, the user can know required information in real time through the display screen 112, so that user experience is better.

The contents not described in detail in this specification are known to those skilled in the art.

The foregoing illustrates and describes the basic principles and main features of the present disclosure and its advantages. Those skilled in the art should understand that the present disclosure is not limited to the embodiments described above. The embodiments and descriptions in the specification are intended only to illustrate the principles of the present disclosure. Within the scope and spirit of the present disclosure, various modifications and improvements can be made which fall within the scope of protection defined by the appended claims and their equivalents.

What is claimed is:

1. A food temperature measuring device, comprising
a charging case; and
an elongated food thermometer detachably received in the charging case, wherein the charging case is configured to charge the elongated food thermometer, and comprises a body portion having a pivot axis and an end cap, one end of the end cap is pivoted to the pivot axis of the body portion, and the other end of the end cap rotates clockwise or counterclockwise relative to the body portion by a predetermined angle around the pivot axis;
a receiving space configured for accommodating the elongated food thermometer is defined in the body portion, and an opening is formed in a top end of the body portion corresponding to the receiving space and communicates with the receiving space to allow the elongated food thermometer to be inserted into the receiving space via the opening.

2. The food temperature measuring device according to claim 1, wherein,
a receiving sleeve is provided inside the body portion along a length direction of the body portion, an internal space of the receiving sleeve defines the receiving space.

3. The food temperature measuring device according to claim 2, wherein,
the body portion further comprises a first elastic member mounted inside the receiving sleeve at an end away from the end cap;
one end of the first elastic member has a retaining ring fixed thereto, and
the other end rests against a bottom side of the body portion away from the end cap;
when the elongated food thermometer is inserted into the receiving sleeve, a front end of the elongated food thermometer penetrates into the retaining ring and the first elastic member and enforces the retaining ring to move downwardly and then compresses the first elastic member; and
in a state where the elongated food thermometer is fully stored in the receiving sleeve, the first elastic member is in a compressed state and accumulates elastic potential energy, thereby imparting an elastic restoring force to the elongated food thermometer.

4. The food temperature measuring device according to claim 3, wherein,
when the end cap is separated with the body portion, the elongated food thermometer is automatically ejected from the charging case by releasing the elastic restoring force generated by the first elastic member.

5. The food temperature measuring device according to claim 3, wherein,
a stepped structure is formed on an inner wall of the receiving sleeve, and the stepped structure is configured to stop the retaining ring during the ejection of the elongated food thermometer.

6. The food temperature measuring device according to claim 1, wherein one end of the end cap rotates at an angle of 0 to 45 degrees with respect to the body portion, and the other end of the end cap supports the body portion in an inclined manner in the case where it is rotated away from an upper end of the body portion.

7. The food temperature measuring device according to claim 1, wherein,
the body portion further comprises a pivoting portion defining the pivot axis and simultaneously providing a channel for receiving wires connected to a control circuit board of the elongated food thermometer, the wires are electrically connected to the elongated food thermometer.

8. The food temperature measuring device according to claim 7, wherein,
the end cap further receives a circuit board, a connecting member, and the second elastic member;
one end of the second elastic member rests against the circuit board and is electrically connected thereto, and the other end of the second elastic member passes through the connecting member and is in mutual conduction with a conductive portion provided at the lower end of the connecting member; and
the wires passing through the pivoting portion are electrically connected to the circuit board and in electrical conduction with the elongated food thermometer through the conductive portion.

9. The food temperature measuring device according to claim 8, wherein,
the elongated food thermometer further comprises a charging positive pin located at the upper end thereof, the charging positive pin being in detachable contact with the conductive portion; and
the conductive portion is in electrical conduction with the charging positive pin when one end of the end cap is reset from a rotated position to a position directly above the body portion, thereby charging the elongated food thermometer via a battery in the body portion.

10. The food temperature measuring device according to claim 1, wherein,
the elongated food thermometer is provided therein with a main PCB, a temperature sensor, a communication unit and an antenna unit;
the temperature sensor and the communication unit are both integrated on the main PCB, and the charging positive pin is provided at the upper end of the main PCB;
the temperature sensor is used to sense the obtained temperature information; and
the communication unit is electrically connected to the temperature sensor and send the temperature information to an external terminal device or display apparatus through the antenna unit.

11. The food temperature measuring device according to claim 10, wherein,
a display screen is provided at the body portion of the charging case, and is configured to display at least one of the bellow information including a power value and temperature information obtained by the elongated food thermometer, and a charging status of the elongated food thermometer.

12. A food temperature measuring device, comprising
a charging case; and
an elongated food thermometer detachably received in the charging case,
wherein the charging case is configured to charge the elongated food thermometer, and comprises a body portion and an end cap configured to cover the body portion, the end cap is movably coupled to the body portion so as to make the charging case to be capable of switching between an opening state that the end cap fails to completely cover the body portion and a closed state that the body portion is completely covered by the end cap;
the elongated food thermometer comprises a charging pin and a grounding pin at two opposite ends of the elongated food thermometer respectively, and
a power supply structure is provided at the charging case, and comprises a first electronic conductive portion located at a first portion, corresponding to a location where one of the charging pin and the grounding pin is positioned in the closed state, of the end cap, and a second electronic conductive portion located at a second portion, corresponding to a location where another one of the charging pin and ground pin is positioned, of the body portion.

13. The food temperature measuring device according to claim 12, wherein the end cap is pivoted to a pivot axis of the body portion.

14. The food temperature measuring device according to claim 12, wherein,
the elongated food thermometer is received in the body portion;
a retaining ring and a first elastic member are mounted inside the receiving sleeve at an end away from the end cap; and
after the elongated food thermometer is inserted into the body portion, the front end of the elongated food thermometer penetrates into the retaining ring and the elastic member and compresses the elastic member by the retaining ring.

15. The food temperature measuring device according to claim 14, wherein,
when the elongated food thermometer is fully stored in the body portion, the elastic member is in a compressed state and accumulates elastic potential energy, thereby imparting an elastic force to the elongated food thermometer; and
when the end cap is separated from the the body portion, the end cap releases the pressing force on the elongated food thermometer, and the elongated food thermometer is automatically ejected from the charging case under the elastic restoring force released by the first elastic member.

16. The food temperature measuring device according to claim 15, wherein,
a receiving sleeve is formed on a side of the body portion, and the elongated food thermometer is received in the receiving sleeve; and
a stepped structure is formed on the inner wall of the receiving sleeve, and the stepped structure stops the retaining ring during the ejection of the elongated food thermometer.

17. The food temperature measuring device according to claim 13, wherein one end of the end cap rotates at an angle of 0 to 45 degrees with respect to the body portion, and the other end of the end cap supports the body portion in an inclined manner in the case where it is rotated away from the upper end face of the body portion.

18. The food temperature measuring device according to claim 12, further comprising
a temperature sensor and a communication unit, which are both integrated on a main PCB, wherein
the temperature sensor is configured to sense temperature information to be obtained; and the communication unit is electrically connected to the temperature sensor and send the temperature information to an external terminal device or display apparatus through an antenna unit.

19. The food temperature measuring device according to claim 18, wherein,
the elongated food thermometer comprises a thermometer shell,
the thermometer shell comprises a probe portion for at least partially extending into the food and a handle portion connected to one end of the probe portion; and
the main PCB comprises a first portion located in the probe portion and a second portion extending into the handle portion, the communication unit being located on the first portion and the antenna unit being located on the second portion.

20. A charging case for receiving and charging an elongated food thermometer, comprising
a body portion having a pivot axis;
an end cap comprising a first side end pivoted to the pivot axis of the body portion and a second side end opposite to the first side end and being capable of rotating clockwise or counterclockwise relative to the body portion by a predetermined angle around the pivot axis; and
a receiving space configured for accommodating the elongated food thermometer; wherein the receiving space is defined in the body portion, and an opening is formed in a top end of the body portion corresponding to the receiving space and communicates with the receiving space to allow the elongated food thermometer to be inserted into the receiving space via the opening.
